(19) United States
(12) Patent Application Publication
(10) Pub. No.: US 2004/0169797 A1
(43) Pub. Date: Sep. 2, 2004

(54) Electro-optical panel and electronic equipment

(75) Inventors: Shin Fujita, Chimo-shi (JP); Toru Nimura, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATON, Tokyo (JP)

(21) Appl. No.: 10/779,712

(22) Filed: Feb. 18, 2004

(30) Foreign Application Priority Data
Feb. 21, 2003 (JP) 2003-044365

(51) Int. Cl. G02F 1/1333

(52) U.S. Cl. 349/110

(57) ABSTRACT

The invention enhances the aperture ratio of an electro-optical panel. A light-shielding layer includes a first light-shielding layer and second light-shielding layers. The first light-shielding layer is formed so as to overlap a plurality of scanning lines and a plurality of data lines. Each of the second light-shielding layers is provided on the downside of the direction of rubbing with respect to the corresponding projecting pattern. Each of the projecting patterns is formed such that part thereof overlaps the corresponding data line. The second light-shielding layers overlap the first light-shielding layer. All or part of each of the second light-shielding layers can also function as the first light-shielding layer to increase the area of an aperture.

### BACKGROUND OF THE INVENTION

1. Field of Invention

The present invention relates to an electro-optical panel that has two substrates and projecting patterns to control the distance between the two substrates, and to electronic equipment using the electro-optical panel.

2. Description of Related Art

Liquid crystal panels using liquid crystals as electro-optic material include active-matrix liquid-crystal panels. The active-matrix liquid-crystal panels each have a plurality of scanning lines, a plurality of data lines, and pixels arranged in a matrix and formed corresponding to the crossing points of the data lines and the scanning lines. Each pixel has a thin film transistor (hereinafter, “TFT”) serving as a switching element, a pixel electrode, liquid crystals, and a counter electrode opposing the pixel electrode with the liquid crystals sandwiched therebetween. Sequentially selecting the scanning lines turns on the TFT connected to the corresponding scanning line and causes image signals supplied to the data line to be captured in the pixel to store the electric charge in a liquid-crystal capacitor.

Each of such liquid crystal panels has an element substrate and a counter substrate. The scanning lines, the data lines, and the TFTs are formed on the element substrate. Light-shielding layers, counter electrodes, and so on are formed beneath the counter substrate. The cell gap between the element substrate and the counter substrate is filled with the liquid crystals. Projecting patterns are sometimes formed under the counter substrate in order to maintain the cell-gap interval at a certain value.

The provision of the projecting patterns causes a nonuniformity of rubbing, making it impossible to control the direction of liquid crystal molecules. Light leakage occurs during display and significantly degrades the image quality. Accordingly, in order to prevent the light leakage due to the projecting patterns, the light-shielding layers must be provided over apertures. In order to increase the brightness of the liquid crystal panel, the apertures must have large areas.

A related art technology exists in which only the apertures for the pixels for which the projecting patterns are provided are covered with light-shielding layers. See Japanese Unexamined Patent Application Publication No. 2002-341329 (FIG. 1). FIG. 20 is a schematic showing the relationship between light-shielding layers and projecting patterns according to the related art. Arrows in FIG. 20 represent the direction of rubbing. As shown in FIG. 20, a narrow aperture K1 is formed for each pixel for which a projecting pattern T is provided, while a wide aperture K2 is formed for each pixel for which the projecting pattern T is not provided. The aperture K1 is separated from the aperture K2 with light-shielding layers S1 and S2. The light-shielding layer S1 is provided for each pixel for which the projecting pattern T is provided. The light-shielding layers S1 prevent the light leakage.

### SUMMARY OF THE INVENTION

Since the projecting patterns T are provided at edges of the light-shielding layer S2 according to the related art, it is necessary to provide the light-shielding layers S1 to prevent the light leakage, in addition to the light-shielding layer S2. The relationship between the projecting patterns T and a variety of wiring is not considered at all. In order to enhance the aperture ratio, only the removal of the light-shielding layer S1 for each pixel for which the projecting pattern T is not provided is done in the related art.

The present invention further enhances the aperture ratio.

In order to address the above problems, an aspect of the present invention provides an electro-optical panel including a first substrate on which a plurality of scanning lines and a plurality of data lines are formed; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. The projecting patterns are formed such that all or part of each of the projecting patterns overlaps the corresponding data line. Second light-shielding layers to reduce or prevent light leakage due to the formation of the projecting patterns are formed so as to overlap the first light-shielding layer and all or part of each of the second light-shielding layers also functions as the first light-shielding layer.

According to an aspect of the present invention, since the projecting pattern overlaps the data line, all or part of the second light-shielding layer can also function as the first light-shielding layer. Hence, it is possible to reduce the area of the second light-shielding layer covering the aperture, thus enhancing the aperture ratio. The center of the projecting pattern is preferably formed on the data line in order to further enhance the aperture ratio. In this specification, when the shape of the end face of the projecting pattern is a circle, “the center of the projecting pattern” refers to the center of the circle. However, when the projecting pattern has a complicated shape at its end face, “the center of the projecting pattern” refers to the center of gravity of the shape.

An aspect of the present invention provides an electro-optical panel including a first substrate on which a plurality of scanning lines and a plurality of data lines are formed; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. The projecting patterns are formed such that all or part of each of the projecting patterns overlaps the corresponding scanning line. Second light-shielding layers to reduce or prevent light leakage due to the formation of the projecting patterns are formed so as to overlap the first light-shielding layer and all or part of each of the second light-shielding layers also functions as the first light-shielding layer.

According to an aspect of the present invention, since the projecting pattern overlaps the scanning line, all or part of the second light-shielding layer can also function as the first light-shielding layer. Hence, it is possible to reduce the area of the second light-shielding layer covering the aperture, thus enhancing the aperture ratio. The center of the projecting pattern is preferably formed on the scanning line in order to further enhance the aperture ratio.

An aspect of the present invention provides an electro-optical panel including a first substrate on which a plurality of scanning lines, a plurality of data lines, and a plurality of capacitive lines are formed; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. The projecting patterns are formed such that all or part of each of the projecting patterns overlaps the corresponding capacitive line. Second light-shielding layers to reduce or prevent light leakage due to the formation of the projecting patterns are formed so as to overlap the first light-shielding layer and all or part of each of the second light-shielding layers also functions as the first light-shielding layer.

Since the capacitive line has a large line width and excellent smoothness, the insulators over the capacitive line have a good film thickness and smoothness. Hence, it is possible to stably form the projecting pattern 10 and to precisely control the cell-gap interval according to an aspect of the present invention. The center of the projecting pattern is preferably formed on the capacitive line.

An aspect of the present invention provides an electro-optical panel including a first substrate on which a plurality of scanning lines, a plurality of data lines, and a plurality of capacitive lines are formed; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. All or part of each of the projecting patterns is formed so as to overlap an area surrounded by the corresponding scanning line, data line, and capacitive line. Second light-shielding layers to prevent light leakage due to the formation of the projecting patterns are formed so as to overlap the first light-shielding layer and all or part of each of the second light-shielding layers also functions as the first light-shielding layer.

The surface smoothness of the insulators formed on the first substrate is largely dependent on various patterns under the insulators. Hence, the presence of a plurality of patterns under the insulator on which the projecting pattern 10 is provided is apt to cause the thickness of the insulators in the corresponding area to be nonuniform. According to an aspect of the present invention, since such patterns do not exist in the area surrounded by the corresponding scanning line, data line, and capacitive line, the area has good smoothness. Hence, the projecting pattern can be stably formed to more precisely control the cell-gap interval.

To further enhance the stability, the center of the projecting pattern may be formed in the area surrounded by the scanning line, data line, and capacitive line.

In the electro-optical panel described above, it is preferable that the projecting pattern be provided on the upside of the direction of rubbing with respect to the corresponding data line and that the second light-shielding layers be provided on the downside of the direction of rubbing on the first light-shielding layer.

An aspect of the present invention provides an electro-optical panel including a first substrate on which a plurality of scanning lines and a plurality of data lines are formed, transmissive areas through which light is transmitted and reflective areas from which the light is reflected being formed on areas surrounded by the data lines and the scanning lines; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. The projecting patterns are formed so as to overlap the first light-shielding layer. Second light-shielding layers to reduce or prevent light leakage due to the formation of the projecting patterns are formed so as to overlap the first light-shielding layer and all or part of each of the second light-shielding layers also functions as the first light-shielding layer. Each of the reflective areas is formed on the downside of the direction of rubbing with respect to the corresponding projecting pattern.

In the transflective electro-optical panel, the light leakage due to the projecting pattern is less visible in the reflective areas than in the transmissive areas. The light leakage occurs on the downside of the direction of rubbing. Hence, forming the reflective area on the downside of the direction of rubbing with respect the projecting pattern can cause any light leakage to be invisible.

An aspect of the present invention provides an electro-optical panel including a first substrate on which a plurality of scanning lines and a plurality of data lines are formed, transmissive areas through which light is transmitted and reflective areas from which the light is reflected being formed on areas surrounded by the data lines and the scanning lines; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. The projecting patterns are formed so as to overlap the first light-shielding layer. Second light-shielding layers to prevent light leakage due to the formation of the projecting patterns are formed so as to overlap the first light-shielding layer and all or part of each of the second light-shielding layers also functions as the first light-shielding layer. Color filters including blue color filters are formed on the first substrate or beneath the second substrate, and each of the blue color filters is formed on the downside of the direction of rubbing with respect to the corresponding projecting pattern.

In the electro-optical panel capable of color display, the light leakage due to the projecting pattern is less visible in blue color, compared with in other colors (for example, red or green). The light leakage occurs on the downside of the direction of rubbing. Hence, forming the color filters on the downside of the direction of rubbing with respect to the projecting pattern causes any light leakage to be invisible. The color filters may be formed on the first substrate or beneath the second substrate.

An aspect of the present invention provides an electro-optical panel including a first substrate on which a plurality of scanning lines and a plurality of data lines are formed, transmissive areas through which light is transmitted and reflective areas from which the light is reflected being formed on areas surrounded by the data lines and the scanning lines; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. The projecting patterns are formed so as to overlap the first light-shielding layer. Second light-shielding layers to reduce or prevent light leakage due to the formation of the projecting patterns are formed so as to overlap the first light-shielding layer and all or part of each of the second light-shielding layers also functions as the first light-shielding layer. Color filters are formed on the first substrate or beneath the second substrate, and third light-shielding layers are formed so that the color filters having the same color have apertures with the same area.

The color densities of the color filters must be controlled in accordance with the areas of the apertures. If the color filters having the same color have the apertures with different areas, the pixels for which the second light-shielding layers are provided must be different in color density, thus complicating the manufacturing process of the color filters. According to an aspect of the present invention, the provision of the third light-shielding layers so as to cause the apertures to have the same area facilitates the color design and manufacture of the color filters. The aperture here refers to the area through which the light contributing to the display of images transmits. For example, the area surrounded by the light-shielding layers corresponds to the apertures “The same area” refers to not only exactly the same area but also the same area including errors in the manufacturing process.

An aspect of the present invention provides an electro-optical panel including a first substrate on which a plurality of scanning lines and a plurality of data lines are formed, transmissive areas through which light is transmitted and reflective areas from which the light is reflected being formed on areas surrounded by the data lines and the scanning lines; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. Color filters of blue, green, and red are formed on the first substrate or beneath the second substrate. The projecting patterns are formed so as to overlap the first light-shielding layer for every predetermined number of rows and are arranged such that the pair of colors of the color filters that are laterally adjacent to each projecting pattern is different for every row and all the pairs of colors appear for every predetermined number of rows. Second light-shielding layers to reduce or prevent light leakage due to the formation of the projecting patterns are formed so as to overlap the first light-shielding layer and all or part of each of the second light-shielding layers also functions as the first light-shielding layer.

According to an aspect of the present invention, the pair of colors of the color filters that are laterally adjacent to the projecting pattern is different for every row, and the projecting patterns are arranged such that all the pairs of colors appear for every predetermined number of rows. The arrangement of the projecting patterns in this manner allows the aperture ratios of the color filters of three colors to be identical and, therefore, allows the brightness of three colors to be uniform. In addition, there is no need to provide the third light-shielding layers, thus increasing the aperture ratio of the entire liquid crystal panel.

The projecting patterns may be arranged between red pixels (color filters) and green pixels in the n-th (n is a natural number) row, may be arranged between green pixels and blue pixels in the (n+1)-th row, and may be arranged between blue pixels and red pixels in the (n+2)-th row. Alternatively, the projecting patterns may be arranged between the red pixels and the green pixels in the n-th (n is a natural number) row, may be arranged between the blue pixels and the red pixels in the (n+1)-th row, and may be arranged between the green pixels and the blue pixels in the (n+2)-th row.

An aspect of the present invention provides an electro-optical panel including a first substrate on which a plurality of scanning lines and a plurality of data lines are formed, transmissive areas through which light is transmitted and reflective areas from which the light is reflected being formed on areas surrounded by the data lines and the scanning lines; a second substrate beneath which a first light-shielding layer that covers the scanning lines and the data lines when the electro-optical panel is assembled is formed; projecting patterns, formed on the first substrate or beneath the second substrate, to control the distance between the first substrate and the second substrate; and electro-optic material filled between the first substrate and the second substrate. The projecting patterns are formed on flat areas over the first light-shielding layer. Second light-shielding layers to reduce or prevent light leakage due to the formation of the projecting patterns are formed so as to overlap the first light-shielding layer and all or part of each of the second light-shielding layers also functions as the first light-shielding layer.

According to an aspect of the present invention, the projecting patterns can be formed on the flat areas to precisely control the cell-gap interval. For example, the projecting patterns are formed on the flat areas, excluding areas having an ununiform height, such as undulated areas due to the effect of ridges and valleys formed in the reflective areas or areas where contact holes are formed.

An aspect of the present invention provides electronic equipment having any of the electro-optical panels described above. For example, the electronic equipment may include a viewfinder in a video camera, a mobile phone, a laptop, and a video projector.

### BRIEF DESCRIPTION OF THE DRAWINGS

FIG. 1 is a perspective view showing the structure of a liquid crystal panel AA according to a first exemplary embodiment of the present invention.

FIG. 2 is a cross-sectional view taken along plane Z-Z′ in FIG. 1.

FIG. 3 is a schematic circuit diagram showing the electrical structure of an image display area A formed on an element substrate 151.

FIG. 4 is a schematic plan view showing an example of the relationship among a projecting pattern, a data line, a scanning line, and light-shielding layers in the liquid crystal panel AA of the first exemplary embodiment.

FIG. 5 is a schematic plan view showing another example of the relationship among the projecting pattern, the data line, the scanning line, and the light-shielding layers in the liquid crystal panel AA of the first exemplary embodiment.

FIG. 6 is a schematic plan view showing the relationship between an aperture and the light-shielding layer in the liquid crystal panel AA of the first exemplary embodiment.

FIG. 7 is a plan view showing in detail the structure of a pixel around a projecting pattern 10 in the liquid crystal panel AA of the first exemplary embodiment.

FIG. 8 is a cross-sectional view taken along plane A-A′ in FIG. 7.

FIG. 9 is a plan view showing in detail the structure of a pixel around a projecting pattern 10 in a liquid crystal panel AA according to a second exemplary embodiment of the present invention.

FIG. 10 is a schematic plan view showing an example of the relationship among a projecting pattern, a data line, a scanning line, and light-shielding layers in the liquid crystal panel AA of the second exemplary embodiment.

FIG. 11 is a schematic plan view showing another example of the relationship among the projecting pattern, the data line, the scanning line, and the light-shielding layers in the liquid crystal panel AA of the second exemplary embodiment.

FIG. 12 is a plan view showing in detail the structure of a pixel around a projecting pattern 10 in a liquid crystal panel AA according to a third exemplary embodiment of the present invention.

FIG. 13 is a plan view showing in detail the structure of a pixel around a projecting pattern 10 in a liquid crystal panel AA according to a fourth exemplary embodiment of the present invention.

FIG. 14 is a schematic showing the relationship among projecting patterns, light-shielding layers, and color filters in a liquid crystal panel AA according to a fifth exemplary embodiment of the present invention.

FIG. 15 is a schematic showing the relationship among projecting patterns, light-shielding layers, and color filters in a liquid crystal panel AA according to a sixth exemplary embodiment of the present invention.

FIGS. 16A and 16B are plan views showing in detail the structure of a liquid crystal panel AA according to a seventh exemplary embodiment of the present invention.

FIG. 17 is a cross-sectional view of a video projector that is an example of electronic equipment to which the liquid crystal device can be applied.

FIG. 18 is a perspective view showing the structure of a personal computer that is an example of the electronic equipment to which the liquid crystal device can be applied.

FIG. 19 is a perspective view showing the structure of a mobile phone that is an example of the electronic equipment to which the liquid crystal device can be applied.

FIG. 20 is a schematic plan view showing the relationship between light-shielding layers and projecting patterns according to the related art.

### DETAILED DESCRIPTION OF PREFERRED EMBODIMENTS

### 1. First Exemplary Embodiment

1-1: Overall Structure of Liquid Crystal Panel

A liquid crystal device using liquid crystals as electro-optic material will now be described as an example of an electro-optical device of an aspect of the present invention. The liquid crystal device has a liquid crystal panel AA as a main part. The liquid crystal panel AA has an element substrate on which thin film transistors (hereinafter “TFTs”) serving as switching elements are formed, a counter substrate, and liquid crystals sandwiched therebetween. The plane of the element substrate where electrodes are formed opposes the plane of the counter substrate where electrodes are formed, and the element substrate is bonded to the counter substrate with a predetermined gap maintained. The liquid crystals are sandwiched in the gap.

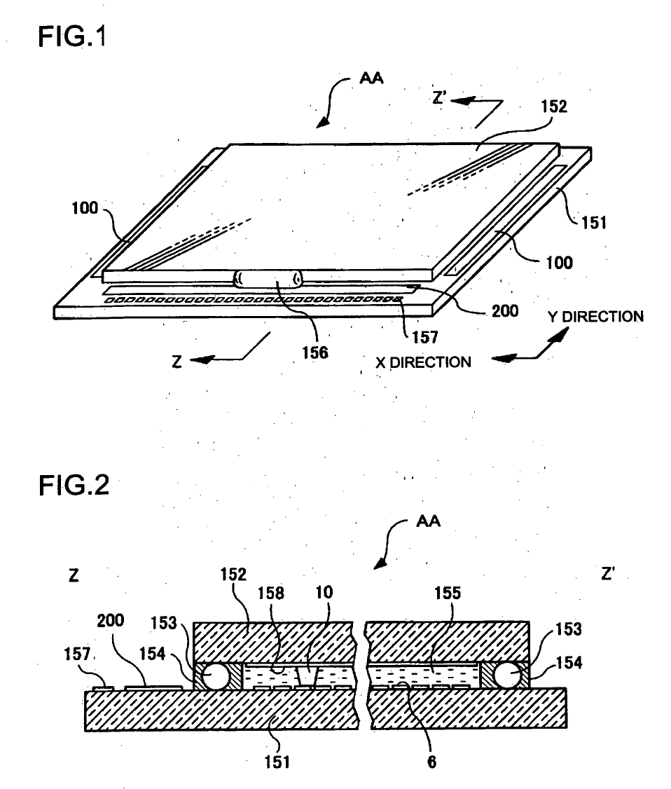

The overall structure of the liquid crystal panel AA will now be described with reference to FIGS. 1 and 2. FIG. 1 is a perspective view showing the structure of the liquid crystal panel AA. FIG. 2 is a cross-sectional view taken along plane Z-Z′.

Referring to FIGS. 1 and 2, the liquid crystal panel AA has a structure in which an element substrate 151 made of glass, semiconductor, or the like, on which pixel electrodes 6 and so on are formed, is bonded to a transparent counter substrate 152 made of glass or the like, beneath which counter electrodes 158 and so on are formed, with a predetermined gap maintained with a sealing material 154 including spacers 153 such that the face of the element substrate 151 where the electrodes are formed opposes the face of the counter substrate 152 where the electrodes are formed. Liquid crystals 155, which are electro-optic material, are enclosed in the gap. Inside the sealing material 154, projecting patterns 10 are provided under the counter substrate 152. The projecting patterns 10 maintain the cell-gap interval in an image display area at a certain value. The sealing material 154 is formed along the periphery of the counter substrate 152 and part of the sealing material 154 is open for injecting the liquid crystals 155. After the liquid crystals 155 are injected, the open part is sealed with a sealant 156.

A data-line driving circuit 200 for driving data lines 3 extending in the Y direction is formed along one side outside the sealing material 154 on the surface of the element substrate 151 opposing to the counter substrate 152. A plurality of connection electrodes 157 for receiving various signals from a timing generating circuit or image signals are formed along this side. Scanning-line driving circuits 100 for driving scanning lines 2 extending in the X direction from both sides are formed along two sides adjacent to the side along which the data-line driving circuit 200 is formed.

The counter electrodes 158 beneath the counter substrate 152 are electrically connected to the element substrate 151 with conductive material provided at at least one corner among four corners bonded to the element substrate 151. In addition to the conductive material, for example, first, color filters arranged in stripes, in a mosaic, in a triangle, or in another pattern; and second, a black matrix made of black resin or the like in which metal material, such as chromium or nickel, carbon, or titanium is dispersed in photoresist are provided beneath the counter substrate 152; and third, a backlight irradiating light on the liquid crystal panel AA is provided behind the counter substrate 152, depending on the application of the liquid crystal panel AA. Particularly, for optical modulation, the black matrix is provided beneath the counter substrate 152 without the color filters.

Alignment films, each undergoing a rubbing process in a predetermined direction, are provided on the respective opposing faces of the element substrate 151 and the counter substrate 152. Polarizing plates (not shown) in accordance with the corresponding alignment directions are provided on the respective back sides of the element substrate 151 and the counter substrate 152. However, using polymer dispersed liquid crystals in which liquid crystals 155 are dispersed in polymers as microparticles eliminates the need for the alignment films and the polarizing plates described above, thus increasing the efficiency of light utilization to advantageously increase the luminance and reduce the power consumption.

A driving IC chip that is mounted on a film by using, for example, a tape automated bonding (TAB) technology may be electrically and mechanically connected to the element substrate 151 through an anisotropic conductive film, which is provided at a predetermined position on the element substrate 151, instead of all or part of peripheral circuits, such as the data-line driving circuit 200 and the scanning-line driving circuits 100 being formed on the element substrate 151. Or, the driving IC chip itself may be electrically and mechanically connected to a predetermined position on the element substrate 151 through the anisotropic conductive film by using a chip on glass (COG) technology.

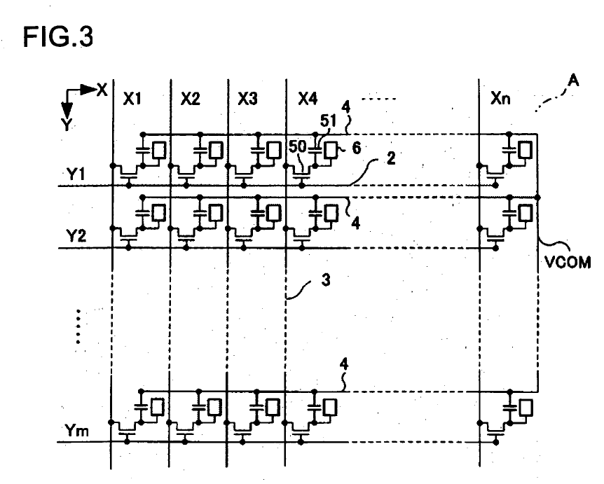

FIG. 3 is a circuit schematic showing the electrical structure of an image display area A formed on the element substrate 151. On the image display area A, as shown in FIG. 3, m (m is a natural number larger than or equal to two) number of scanning lines 2 are arranged in parallel in the X direction, while n (n is a natural number larger than or equal to two) number of data lines 3 are arranged in parallel in the Y direction. Near each of the crossing points of the scanning lines 2 and the data lines 3, the gate of a TFT 50 is connected to the corresponding scanning line 2, while the source of the TFT 50 is connected to the corresponding data line 3 and the drain of the TFT 50 is connected to the corresponding pixel electrode 6. Each pixel includes the pixel electrode 6, the counter electrode 158 formed beneath the counter substrate 152, and the liquid crystals 155 sandwiched therebetween. As a result, the pixels are arranged in a matrix form, corresponding to the crossing points of the scanning lines 2 and the data lines 3.

Scanning signals Y1, Y2, . . . , Ym are linearly and sequentially applied to each scanning line 2 connected to the gate of the TFT 50 as pulses. Hence,.supplying the scanning signals to one of the scanning lines 2 turns on the corresponding TFT 50 connected to the scanning line 2, so that image signals X1, X2, . . . , Xn, supplied from the data line 3 at a predetermined timing, are sequentially written into the corresponding pixel to be stored for a predetermined time period.

Since the orientation or order of liquid crystal molecules vary in accordance with the voltage level applied to the pixel, the gradation display can be achieved by the optical modulation. For example, the amount of light passing through the liquid crystals is decreased as the applied voltage increases in a normally white mode, while the amount of light is increased as the applied voltage increases in a normally black mode. Accordingly, as for the overall liquid crystal device, the light having a contrast corresponding to the image signal is emitted from each pixel, thus realizing predetermined display.

In order to reduce or prevent the stored image signal from leaking, a storage capacitor 51 is connected in parallel to a liquid-crystal capacitor formed between the pixel electrode 6 and the counter electrode 158. The storage capacitor 51 is formed between a capacitive line 4 and the drain of the corresponding TFT 50. For example, since the voltage of the pixel electrode 6 is stored in the storage capacitor 51 for a time period longer than the time period during which the source voltage is applied by three orders of magnitude, the retention characteristics are enhanced, thus achieving a high contrast ratio.

1-2: Arrangement of Projecting Pattern

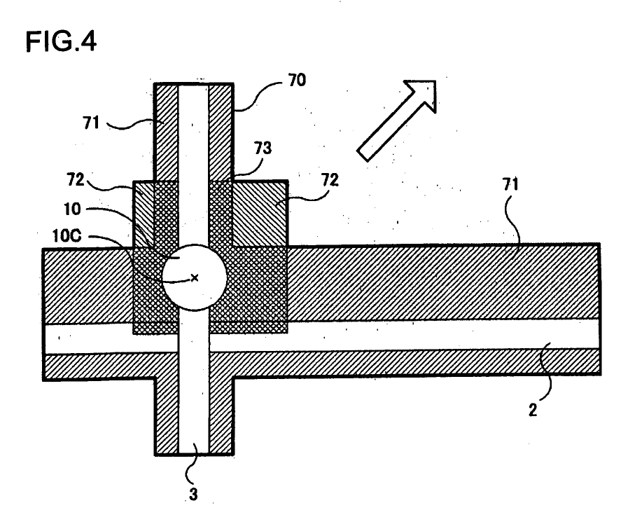

FIG. 4 is a schematic plan view showing the relationship among a projecting pattern, a data line, a scanning line, and light-shielding layers. Referring to FIG. 4, an arrow represents the direction of rubbing. An area surrounded by a thick line represents a light-shielding shielding layer 70, which is formed in a black matrix or the like. Although the light-shielding layer 70 in FIG. 4 is formed beneath the counter substrate 152, it may be formed on the element substrate 151. The light-shielding layer 70 includes a first light-shielding layer 71 and second light-shielding layers 72. The first light-shielding layer 71 is formed so as to cover the scanning line 2 and the data line 3. An area outside the scanning line 2 and the data line 3, in the first light-shielding layer 71, is determined in consideration of, first, a displacement occurring in the bonding of the element substrate 151 to the counter substrate 152; second, the starting point of the pixel electrode; and, third, masking of a reverse tilt domain of the liquid crystal in accordance with the direction of torsion. The second light-shielding layers 72 are provided to reduce or prevent light leakage caused by nonuniformity of rubbing due to the formation of the projecting pattern 10. The light leakage occurs on the downside of the direction of rubbing with respect to the projecting pattern 10. Hence, each of the second light-shielding layers 72 is provided on the downside of the direction of rubbing with respect to the projecting pattern 10.

Part of the projecting pattern 10 is formed so as to overlap the corresponding data line 3. As described above, since the first light-shielding layer 71 is formed so as to cover the data line 3, arranging the projecting pattern 10 such that part of the projecting pattern 10 overlaps the data line 3 causes the second light-shielding layer 72 to overlap the first light-shielding layer 71. In FIG. 4, the first light-shielding layer 71 overlaps the second light-shielding layer 72 in a mesh area 73. In other words, all or part of the second light-shielding layer 72 also functions as the first light-shielding layer 71 by forming the second light-shielding layer 72 so as to overlap the first light-shielding layer 71. Hence, the area of the second light-shielding layer 72 outside the first light-shielding layer 71 can be reduced, thus increasing the area of an aperture.

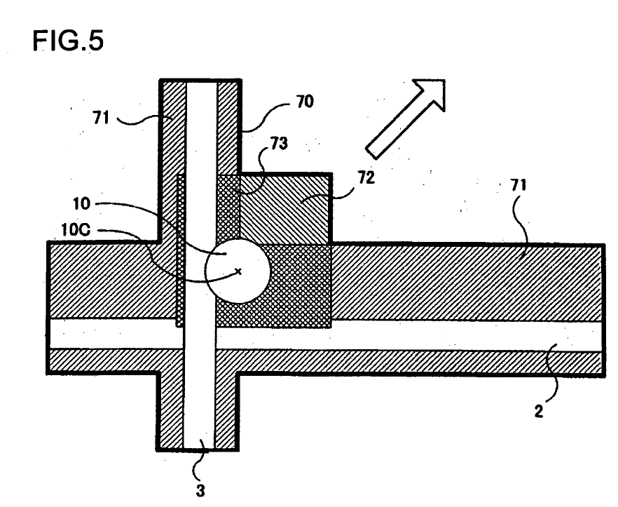

The case in which part of the projecting pattern 10 overlaps the data line 3 includes a case in which the center 10C of the projecting pattern 10 is not on the data line 3 shown in FIG. 5. However, with the object of sharing the second light-shielding layer 72 with the first light-shielding layer 71 to enhance the aperture ratio, the center 10C is preferably on the data line 3, as shown in FIG. 4.

Although the diameter of the projecting pattern 10 is larger than the width of the data line 3 in FIG. 4, the overall projecting pattern 10 may be on the data line 3 depending on the shape of the projecting pattern 10 or the width of the data line 3. Also in such a case, the aperture ratio can be enhanced.

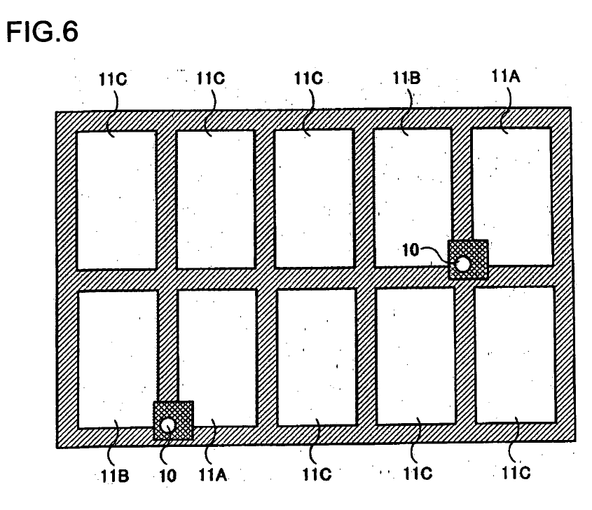

FIG. 6 is a schematic showing the relationship between apertures 11 and the light-shielding layer 70. An area surrounded by the light-shielding layer 70 represents each aperture 11. The apertures 11 are classified according to their areas into three types; 11A, 11B, and 11C. The area of 11C is larger than the area of 11B that is larger than the area of 11A. When color filters are provided in the apertures 11, it is desirable to adjust the color density in accordance with the areas.

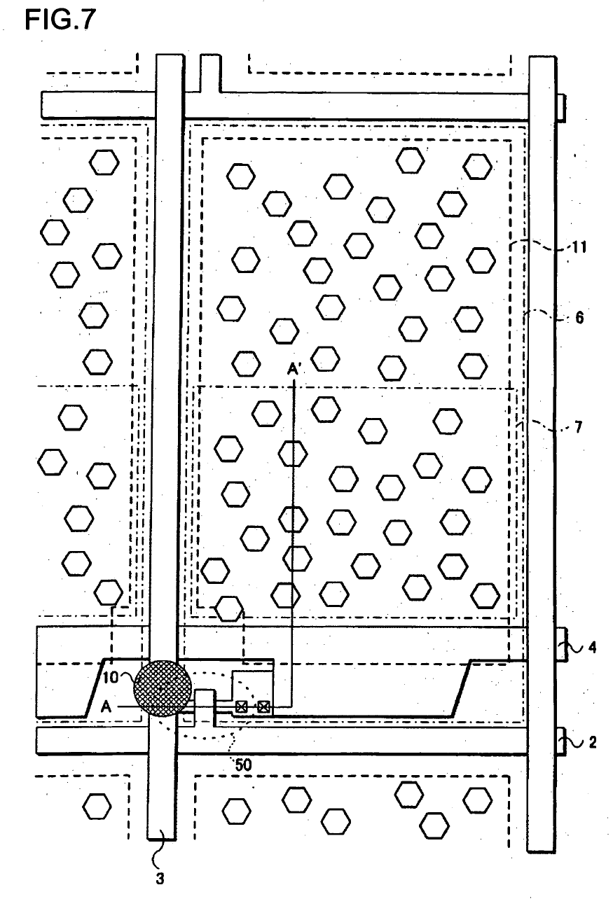

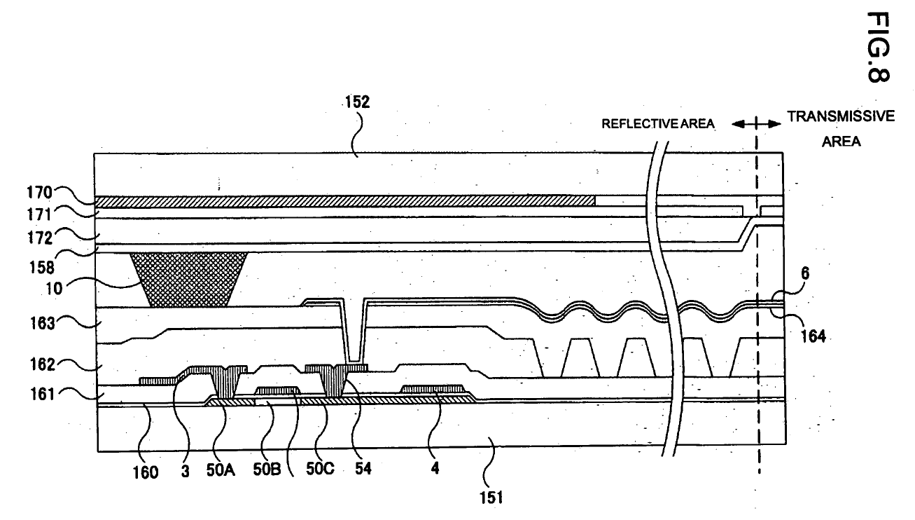

FIG. 7 illustrates the structure of a pixel around the projecting pattern 10 in detail. FIG. 8 is a cross-sectional view taken along plane A-A′ in FIG. 7. Although the structure of the transflective liquid crystal panel AA is exemplified in FIGS. 7 and 8, the exemplary embodiment can obviously be applied to a transmissive liquid crystal panel or a reflective liquid crystal panel.

Semiconductor layers (a source region 50A, a drain region 50B, and a drain region 50C) are formed on the element substrate 151 by using a planar process. The source region 50A and the drain region 50B are ion-doped to form a heavily doped impurity region. A gate insulator 160 is formed on the semiconductor layers (the source region 50A, the drain region 50B, and the drain region 50C). The scanning line 2 (gate line) and the capacitive line 4 are formed on the gate insulator 160. Specifically, conductive material, such as aluminum, is laminated by sputtering or the like and a pattern is formed by photolithography, etching, or the like. A first interlayer insulator 161 is formed on the scanning line 2 and the capacitive line 4, and contact holes are formed by dry etching, such as reactive etching or reactive ion-beam etching, or by wet etching. The data line 3 (source line) and a drain electrode 54 are formed by patterning. The storage capacitor 51 (refer to FIG. 3) is formed from the capacitive line 4, which opposes part of the drain region 50C of the TFT 50 through the gate insulator 160.

A lower second interlayer insulator 162 is formed on the data line 3 (source line) and the drain electrode 54. A patterning is performed in a reflective area to form ridges and valleys, and an upper second interlayer insulator 163 is formed on the lower second interlayer insulator 162. This leads to the formation of the wavelike ridges and valleys on the reflective area. Although the complete holes are formed in the lower second interlayer insulator 162 by the patterning in FIG. 8, exposure time may be controlled not to form the complete holes and the upper second interlayer insulator 163 may be omitted.

After the wavelike ridges and valleys are formed in the reflective area, a contact hole is formed by the dry etching or the wet etching. A reflecting electrode 164 is formed on the upper second interlayer insulator 163 by the patterning, and then the pixel electrode 6 is formed on the reflecting electrode 164 by the patterning. The reflecting electrode 164 is made of aluminum or silver. The pixel electrode 6 is made of transparent material, such as indium tin oxide (ITO). An alignment film (not shown) is formed on the pixel electrodes 6 made of ITO and undergoes the rubbing process.

A light-shielding layer 170 is formed beneath the counter substrate 152. The light-shielding layer 170 is made of black resin in which chromium metal, carbon, or titanium is dispersed in photoresist, metallic material, such as nickel, or the like. A laminated structure made of not less than two kinds of material, including the above material, may be formed. A color filter 171 is formed beneath the light-shielding layer 170, and a cell-gap adjusting pattern 172 is formed beneath the color filter 171 in the reflective area. Accordingly, the cell-gap interval in the reflective area is smaller than the cell-gap interval in a transmissive area, thus causing the optical characteristic of the reflective area to be close to that of the transmissive area.

The counter electrode 158 is formed beneath the cell-gap adjusting pattern 172. The counter electrode 158 is made of transparent material, such as indium tin oxide (ITO). The projecting pattern 10 is formed at one of the predetermined positions described above beneath the counter electrode 158. The projecting pattern 10 is made of, for example, acrylic resin or polyimide. The projecting pattern 10 is molded or patterned by forming an original film made of the above material and, then, etching the original film by applying a photolithography technology. With this formation method, the shape of the projecting pattern 10 can be freely determined in accordance with an exposure process (patterning) for a resist film formed on the original film. Although the projecting pattern 10 substantially has the shape of a frustum of a cone in FIG. 8, it may have the shape of a quadrangular prism or a cylinder. The alignment film (not shown) is formed beneath the projecting pattern 10 and undergoes the rubbing process.

The element substrate 151 is bonded to the counter substrate 152 such that the pixel electrode 6 opposes the counter electrode 158. Since the projecting pattern 10 controls the cell-gap interval, the element substrate 151 is bonded to the counter substrate 152 with a predetermined gap maintained.

### 2. Second Exemplary Embodiment

A liquid crystal panel AA according to a second exemplary embodiment will now be described. The liquid crystal panel AA in the second exemplary embodiment is structured in the same manner as the liquid crystal panel AA in the first exemplary embodiment except the arrangement of the projecting patterns 10.

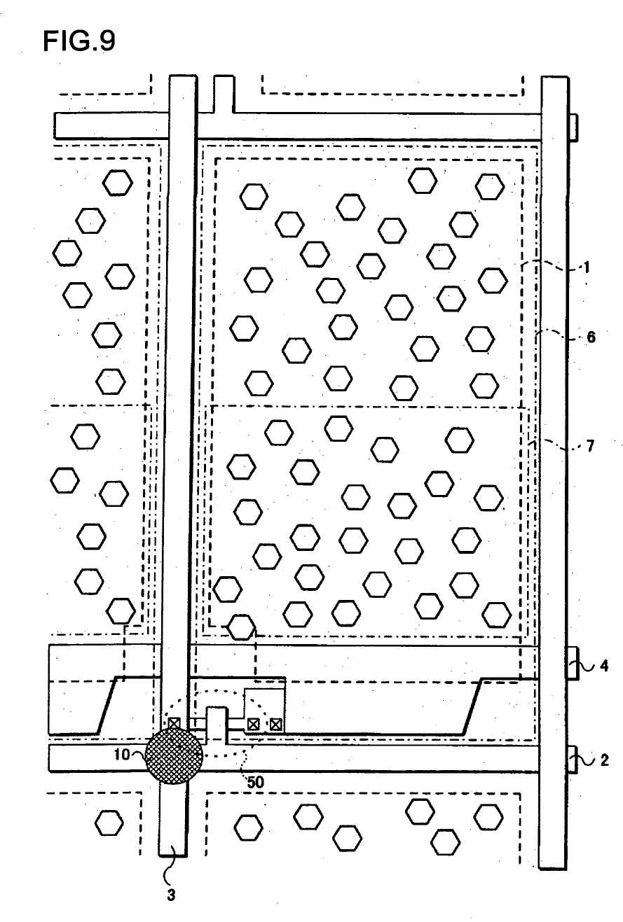

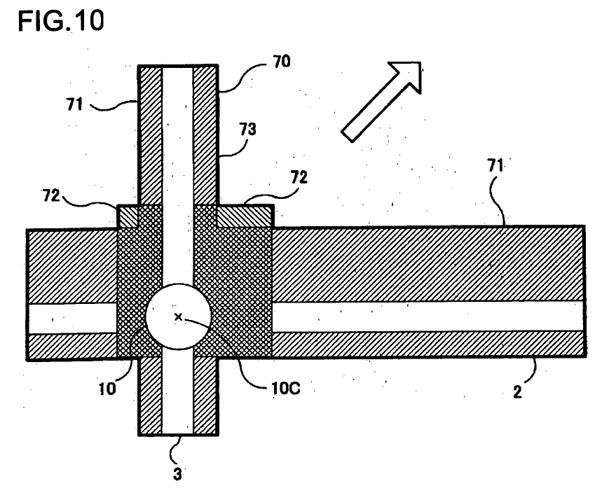

FIG. 9 is a plan view showing in detail the structure of the liquid crystal panel AA according to the second embodiment. FIG. 10 is a schematic plan view showing the relationship among a projecting pattern, a data line, a scanning line, and light-shielding layers in the liquid crystal panel AA. Referring to FIGS. 9 and 10, part of the projecting pattern 10 is formed so as to overlap the scanning line 2. As described above, since the first light-shielding layer 71 is formed so as to cover the scanning line 2, arranging the projecting pattern 10 such that part of the projecting pattern 10 overlaps the scanning line 2 causes the second light-shielding layer 72 to overlap the first light-shielding layer 71 in an area 73. In other words, all or part of the second light-shielding layer 72 also functions as the first light-shielding layer 71 by forming all or part of the projecting pattern 10 so as to overlap the scanning line 2. Hence, the area of the second light-shielding layer 72 outside the first light-shielding layer 71 can be reduced, thus increasing the area of an aperture.

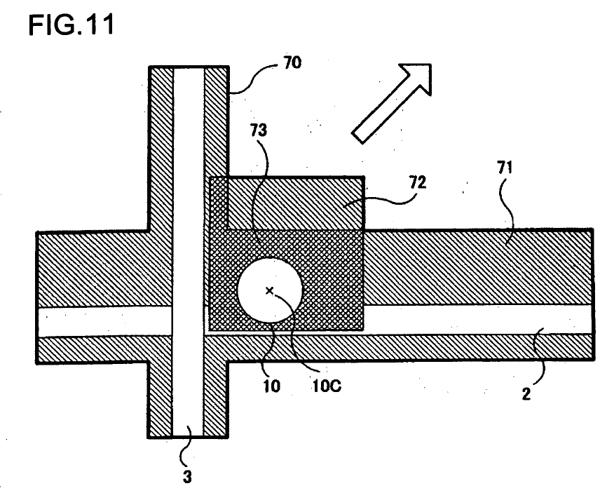

The case in which part of the projecting pattern 10 overlaps the scanning line 2 includes a case in which the center 10C of the projecting pattern 10 is not on the scanning line 2 shown in FIG. 11. However, with the object of sharing the second light-shielding layer 72 with the first light-shielding layer 71 to enhance the aperture ratio, the center 10C may be on the scanning line 2, as shown in FIG. 10. To further enhance the aperture ratio, the center 10C may be in an overlapping area of the data line 3 and the scanning line 2.

### 3. Third Exemplary Embodiment

A liquid crystal panel AA according to a third exemplary embodiment will now be described. The liquid crystal panel AA in the third exemplary embodiment is structured in the same manner as the liquid crystal panel AA in the first exemplary embodiment except the arrangement of the projecting patterns 10.

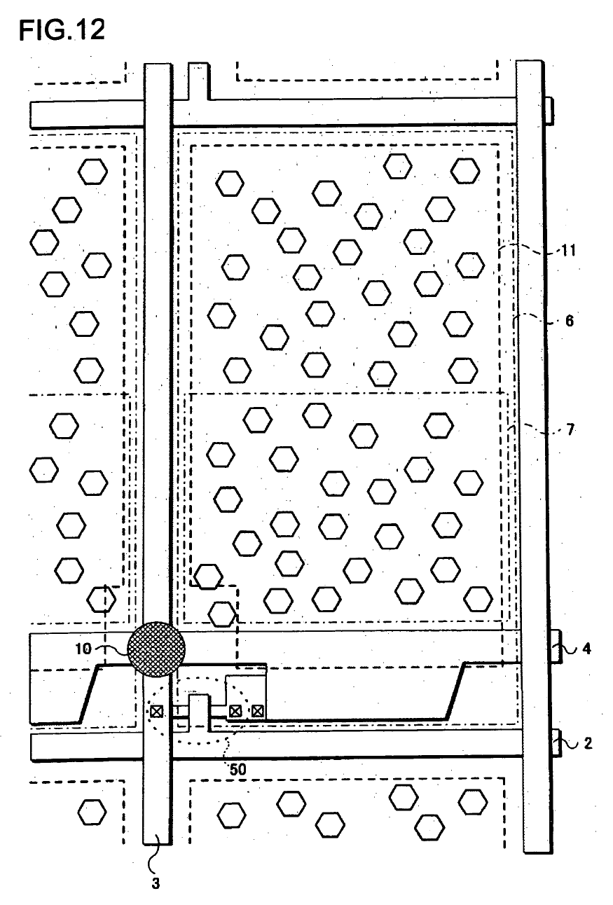

FIG. 12 is a plan view showing in detail the structure of the liquid crystal panel AA according to the third exemplary embodiment. Referring to FIG. 12, the projecting pattern 10 is formed such that part of the projecting pattern 10 overlaps the capacitive line 4. Generally, the surface smoothness of the insulators formed on the element substrate 151 is largely dependent on various patterns under the insulators. Hence, the presence of a plurality of patterns under the insulator on which the projecting pattern 10 is provided is apt to cause the thickness of the insulators in the corresponding area to be nonuniform. However, since the capacitive line 4 has a large line width and excellent smoothness, the insulators over the capacitive line 4 have a good film thickness and smoothness. This is the reason why the projecting pattern 10 is arranged such that part of the projecting pattern 10 overlaps the capacitive line 4. Accordingly, the second light-shielding layer 72 can also advantageously function as the first light-shielding layer 71 to enhance the aperture ratio, and the projecting pattern 10 can be stably formed to precisely control the cell-gap interval.

When the projecting pattern 10 is small, the entire projecting pattern 10 may be on the capacitive line 4. With the object of enhancing the stability, the center of the projecting pattern 10 is preferably on the capacitive line 4.

### 4. Fourth Exemplary Embodiment

A liquid crystal panel AA according to a fourth exemplary embodiment will now be described. The liquid crystal panel AA in the fourth exemplary embodiment is structured in the same manner as the liquid crystal panel AA in the first exemplary embodiment except the arrangement of the projecting patterns 10. In the liquid crystal panel AA according to the fourth exemplary embodiment, the projecting pattern 10 is arranged with the object of enhancing its stability, like the liquid crystal panel AA in the third exemplary embodiment.

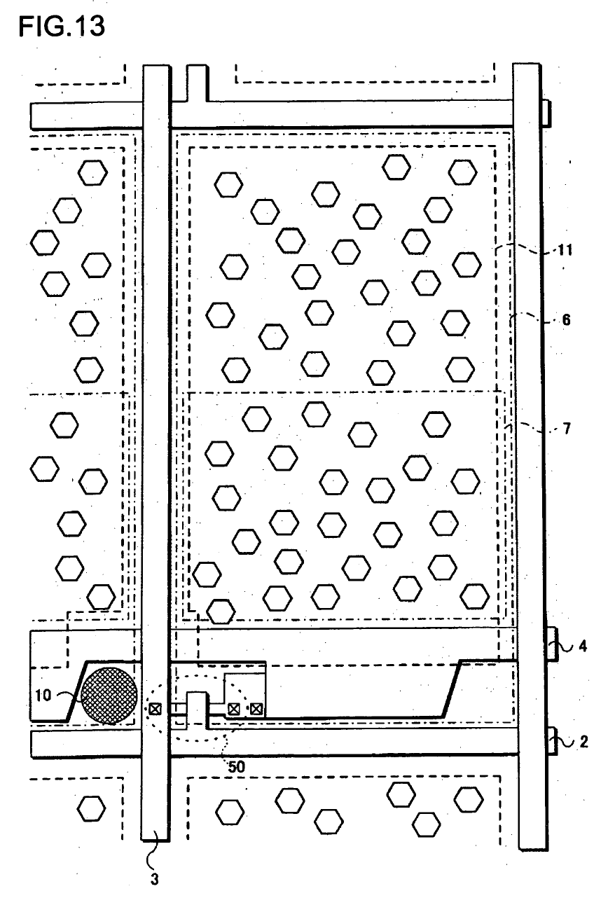

FIG. 13 is a plan view showing in detail the structure of the liquid crystal panel AA according to the fourth exemplary embodiment. Referring to FIG. 13, the projecting pattern 10 is formed such that the entire projecting pattern 10 is in an area surrounded by the scanning line 2, the data line 3, and the capacitive line 4. Since a metal pattern does not exist under the insulators in this area, the insulators in this area have an optimal film thickness and smoothness. Hence, forming the projecting pattern 10 in this area can stably form the projecting pattern 10 to more precisely control the cell-gap interval.

When the projecting pattern 10 is large, part of the projecting pattern 10 may be on this area. To enhance the stability, the center of the projecting pattern 10 may be in this area.

### 5. Fifth Exemplary Embodiment

A liquid crystal panel AA according to a fifth exemplary embodiment will now be described. The liquid crystal panel AA in the fifth exemplary embodiment is structured in the same manner as the liquid crystal panel AA in the first exemplary embodiment except the arrangement of the projecting patterns 10 and the second light-shielding layers 72 and the provision of third light-shielding layers 73.

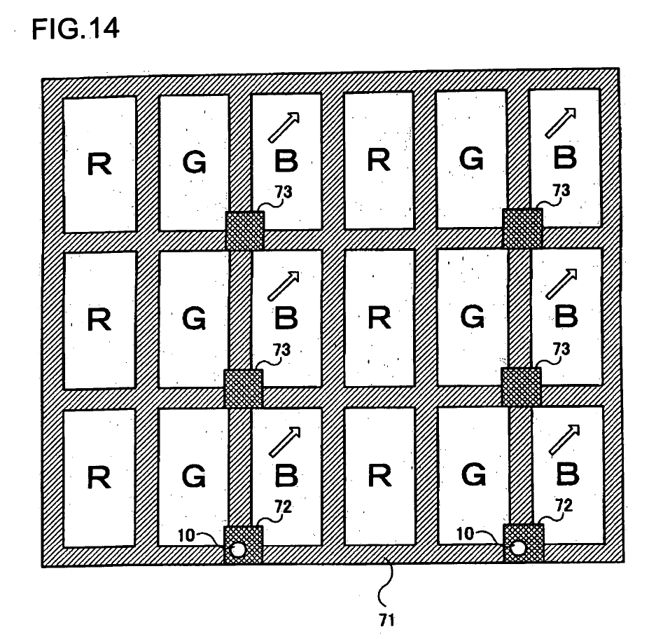

FIG. 14 is a schematic showing the relationship among projecting patterns, light-shielding layers, and color filters in the liquid crystal panel AA of the fifth exemplary embodiment. Referring to FIG. 14, the projecting patterns 10 are formed so as to overlap the first light-shielding layer 71. The second light-shielding layers 72 are formed so as to overlap the first light-shielding layer 71.

Color filters of red (R), green (G), and blue (B) are formed under the counter substrate 152. The projecting patterns 10 are formed on only the upside of the direction of rubbing for some of the blue color filters. The projecting patterns 10 are provided for the blue color filters because any light leakage is invisible in the blue filters, compared with in other color filters. Accordingly, even when the positions at which the projecting patterns 10 are formed are displaced in the manufacturing process or there is an error in the position where the element substrate 151 is bonded to the counter substrate 152 to cause light leakage, the light leakage can be made invisible in the blue color filters.

According to the fifth exemplary embodiment, the third light-shielding layers 73 are provided for pixels having the same color as the pixel for which the projecting pattern 10 is provided, among the pixels for which the projecting pattern 10 is not provided. In other words, the third light-shielding layers 73 are provided so that the color filters having the same color have the apertures with the same area. The color densities of the color filters must be controlled in accordance with the areas of the apertures. If the color filters having the same color have the apertures with different areas, the pixels for which the second light-shielding layers 72 are provided must be different in color density, thus complicating the manufacturing process of the color filters. According to the fifth exemplary embodiment, the provision of the third light-shielding layers 73 facilitates the color design and manufacture of the color filters. Since the provision of the third light-shielding layers 73 reduces the aperture ratio, the third light-shielding layers 73 are not provided in order to give preference to the brightness of the screen.

### 6. Sixth Exemplary Embodiment

A liquid crystal panel AA according to a sixth exemplary embodiment will now be described. The liquid crystal panel AA in the sixth exemplary embodiment is structured in the same manner as the liquid crystal panel AA in the first exemplary embodiment except the arrangement of the projecting patterns 10 and the second light-shielding layers 72.

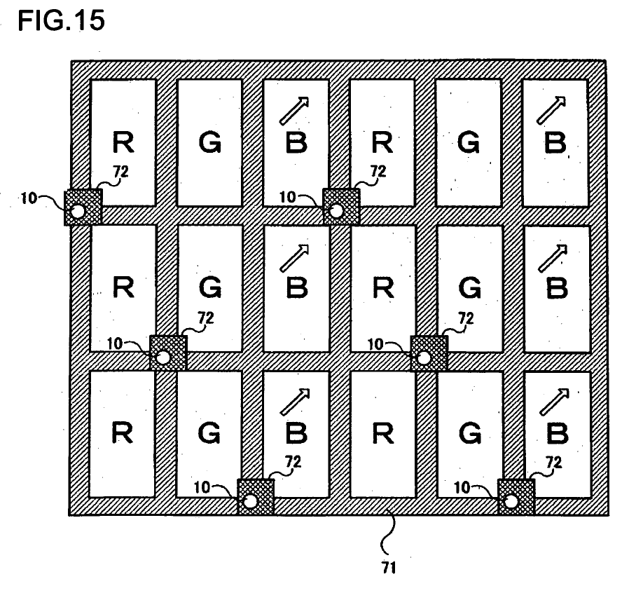

FIG. 15 is a schematic showing the relationship among projecting patterns, light-shielding layers, and color filters in the liquid crystal panel AA of the sixth exemplary embodiment. Referring to FIG. 15, the projecting patterns 10 are formed so as to overlap the first light-shielding layer 71. The second light-shielding layers 72 are formed so as to overlap the first light-shielding layer 71. The pair of colors of the color filters adjacent to the projecting patterns 10 in the first row are B and R, the pair of colors of the color filters adjacent to the projecting patterns 10 in the second row are R and G, and the pair of colors of the color filters adjacent to the projecting patterns 10 in the third row are G and B.

Specifically, the projecting patterns 10 are formed so as to overlap the first light-shielding layer 71 for every row and are arranged such that the pair of colors of the color filters that are laterally adjacent to each projecting pattern is different for every row and all the pairs of colors appear for every three rows. The arrangement of the projecting patterns 10 in this manner allows the aperture ratios of the color filters of three colors to be identical and, therefore, allows the brightness of three colors to be uniform.

Although the projecting patterns 10 are formed for every row in FIG. 15, the projecting patterns 10 may be formed for every predetermined number of rows. Furthermore, although the projecting patterns 10 are arranged such that all the pairs of colors appear for every three rows, the projecting patterns 10 may be arranged such that all the pairs of colors appear for every predetermined number of rows.

### 7. Seventh Exemplary Embodiment

A liquid crystal panel AA according to a seventh exemplary embodiment will now be described. The liquid crystal panel AA in the seventh exemplary embodiment is structured in the same manner as the liquid crystal panel AA in the first exemplary embodiment except the removal of ridges and valleys around the projecting patterns 10.

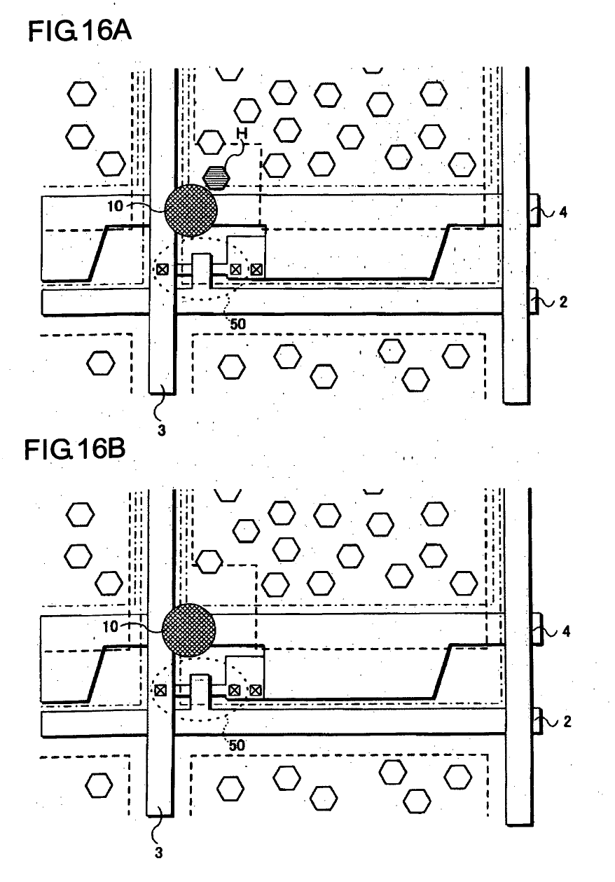

FIG. 16 includes plan views illustrating the structure of the liquid crystal panel AA according to the seventh exemplary embodiment. In the structure shown in FIG. 16(A), a valley H in the reflective area is close to the projecting pattern 10. Hence, the upper second interlayer insulator 163, which is in contact with the projecting pattern 10, is undulated due to the valley H, thus providing an insufficient stability of the projecting pattern 10.

In order to address the above problem, the valley H around the projecting pattern 10 is removed, as shown in FIG. 16(B). As a result, the projecting pattern 10 can be formed on the flat area to precisely control the cell-gap interval. Since ridges and valleys are also generated around the contact hole, the projecting pattern 10 is preferably formed so as not to overlap the contact hole.

### 8. Application

8-1: Structure of Element Substrate etc.

Although, in the liquid crystal panels of the above exemplary embodiments, silicon thin films are formed on the element substrate 151, which is a transparent insulative substrate made of glass or the like, and the TFTs having the source, the drain, and the channel formed on the thin films constitute the switching elements (TFTs 50) of the pixels and the elements in the data-line driving circuit 200 and the scanning-line driving circuits 100, the present invention is not limited to the exemplary embodiments described above.

For example, insulated-gate field-effect transistors having the source, the drain, and the channel formed on the surface of the element substrate 151, which is a semiconductor substrate, may constitute the switching elements of the pixels and the elements in various circuits. Since the liquid crystal panel AA with the element substrate 151 being the semiconductor substrate cannot be used as a transmissive display panel, the liquid crystal panel AA is used as a reflective liquid crystal panel with the pixel electrodes 6 made of aluminum or the like. Or, the element substrate 151 may be a transparent substrate and the pixel electrodes 6 may be a reflective type.

Although the switching elements of the pixels are three-terminal elements typified by the TFTs in the exemplary embodiments described above, they may be two-terminal elements such as diodes. However, in order to use the two-terminal elements as the switching elements of the pixels, it is necessary to form the scanning line 2 on one substrate and form the data line 3 on the other substrate and to form the two-terminal element between either the scanning line 2 or the data line 3 and the pixel electrode 6. In this case, the two-terminal element connected in series between the scanning line 2 and the data line 3 and the liquid crystals constitute each pixel.

Although the active-matrix liquid-crystal display device has been described in the above exemplary embodiments, the present invention is not limited to such a liquid crystal display device. The present invention can be applied to a passive-matrix liquid-crystal display device using super twisted nematic (STN) liquid crystals or the like. The present invention can also be applied to an electrophoretic system, such as electronic paper.

8-2: Electronic Equipment

A case in which the liquid crystal device described above is applied to a variety of electronic equipment will be described below.

8-2-1: Projector

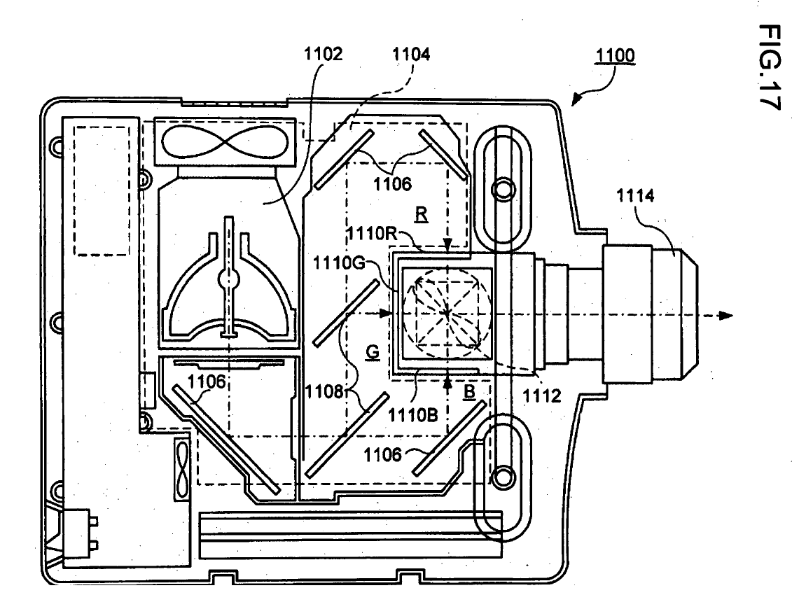

A projector using the liquid crystal device as a light valve will now be described. FIG. 17 is a cross-sectional view showing a structure example of the projector.

Referring to FIG. 17, a projector 1100 includes a lamp unit 1102 that is a white light source, such as a halogen lamp. Light projected from the lamp unit 1102 is separated into three primary colors of R, G, and B with four mirrors 1106 and two dichroic mirrors 1108 arranged in a light guide 1104, and is incident on liquid-crystal panels 1110R, 1110B, and 1110G serving as the light valves corresponding to the primary colors.

The structure of each of the liquid crystal panels 1110R, 1110B, and 1110G is equal to that of the liquid crystal panel AA described above. Each of the liquid crystal panels is driven by the signals for the primary colors R, G, and B supplied from an image-signal processing circuit (not shown). The rays of light modulated by the liquid crystal panels are incident on a dichroic prism 1112 from three directions. The rays of light of R and B are refracted at an angle of 90° in the dichroic prism 1112 and the rays of light of G go straight through the dichroic prism 1112. Hence, images of the three colors are combined to project the color images on a screen or the like through a projector lens 1114.

The images displayed in the liquid-crystal panel 1110G must be mirror-reversed with respect to the images displayed in the liquid-crystal panels 1110R and 1110B.

Since the rays of light corresponding to the primary colors of R, G, and B are incident on the liquid-crystal panels 1110R, 1110B, and 1110G through the dichroic mirrors 1108, the color filters are not required.

8-2-2: Mobile Computer

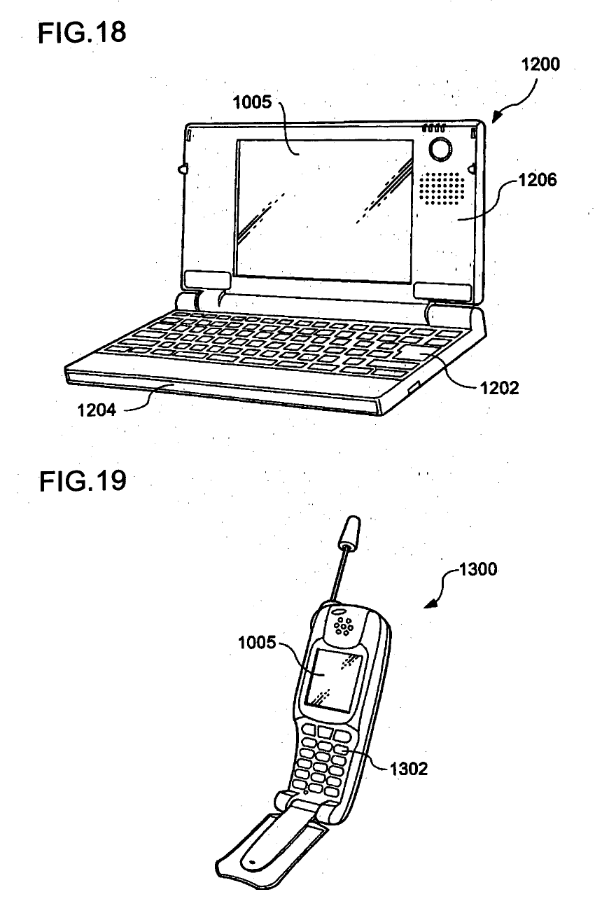

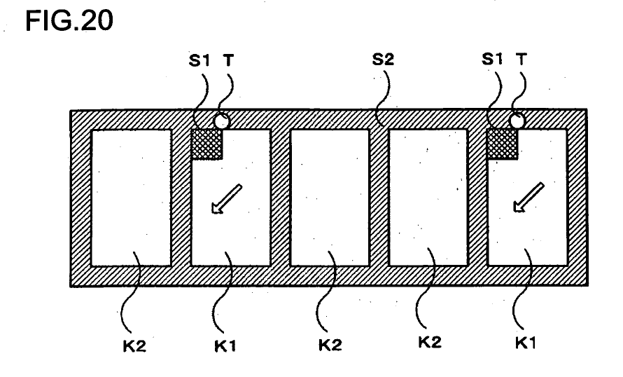

A case in which any of the liquid crystal panels is applied to a mobile personal computer will now be described. FIG. 18 is a perspective view showing the structure of the personal computer. Referring to FIG. 18, a computer 1200 has a main unit 1204 including a keyboard 1202, and a liquid crystal display unit 1206. The liquid crystal display unit 1206 has a liquid crystal panel 1005 having a backlight appended at the back face thereof.

8-2-3: Mobile Phone

A case in which any of the liquid crystal panels is applied to a mobile phone will now be described. FIG. 19 is a perspective view showing the structure of the mobile phone. Referring to FIG. 19, a mobile phone 1300 has a plurality of operation buttons 1302 and a reflective liquid-crystal panel 1005. The reflective liquid-crystal panel 1005 has a front light at the front face thereof, if required.

In addition to the electronic equipment described with reference to FIGS. 17 to 19, electronic equipment to which the liquid crystal panel of an aspect of the present invention can be applied includes, for example, a liquid crystal television set, a video tape recorder with a viewfinder and a monitor for direct viewing, a car navigation system, a pager, an electronic notebook, a desk-top calculator, a word processor, a workstation, a television telephone, a POS terminal, and an apparatus with a touch panel.

What is claimed is:

1. An electro-optical panel, comprising:
a first substrate;
a plurality of scanning lines and a plurality of data lines are formed on the first substrate;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, the projecting patterns being formed such that all or part of each of the projecting patterns overlaps the corresponding data line; and
second light-shielding layers, to prevent light leakage due to the formation of the projecting patterns, formed so as to overlap the first light-shielding layer and all or part of each of the second light-shielding layers that also functions as the first light-shielding layer.

2. The electro-optical panel according to claim 1, the center of the projecting pattern being formed on the corresponding data line.

3. An electro-optical panel, comprising:
a first substrate;
a plurality of scanning lines and a plurality of data lines formed on the first substrate;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, the projecting patterns being formed such that all or part of each of the projecting patterns overlaps the corresponding scanning line; and
second light-shielding layers, to prevent light leakage due to the formation of the projecting patterns, formed so as to overlap the first light-shielding layer and all or part of each of the second light-shielding layers that also functions as the first light-shielding layer.

4. The electro-optical panel according to claim 3, the center of the projecting pattern being formed on the corresponding scanning line.

5. An electro-optical panel, comprising:
a first substrate;
a plurality of scanning lines, a plurality of data lines, and a plurality of capacitive lines formed on the first substrate;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, the projecting patterns being formed such that all or part of each of the projecting patterns overlaps the corresponding capacitive line; and
second light-shielding layers, to prevent light leakage due to the formation of the projecting patterns formed so as to overlap the first light-shielding layer and all or part of each of the second light-shielding layers that also functions as the first light-shielding layer.

6. The electro-optical panel according to claim 5, the center of the projecting pattern being formed on the corresponding capacitive line.

7. An electro-optical panel, comprising:
a first substrate;
a plurality of scanning lines, a plurality of data lines, and a plurality of capacitive lines formed on the first substrate;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, all or part of each of the projecting patterns being formed so as to overlap an area surrounded by the corresponding scanning line, data line, and capacitive line; and
second light-shielding layers to prevent light leakage due to the formation of the projecting patterns formed so as to overlap the first light-shielding layer and all or part of each of the second light-shielding layers also functions as the first light-shielding layer.

8. The electro-optical panel according to claim 7, the center of the projecting pattern being formed in the area surrounded by the corresponding scanning line, data line, and capacitive line.

9. The electro-optical panel according to claim 8, the projecting pattern being provided on the upside of the direction of rubbing with respect to the corresponding data line.

10. The electro-optical panel according to claim 1, the second light-shielding layers being provided on the downside of the direction of rubbing on the first light-shielding layer.

11. An electro-optical panel, comprising:
a first substrate;
a plurality of scanning lines and a plurality of data lines formed on the first substrate;
transmissive areas through which light is transmitted and reflective areas from which the light is reflected being formed on areas surrounded by the data lines and the scanning lines;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, the projecting patterns being formed so as to overlap the first light-shielding layer;
second light-shielding layers to prevent light leakage due to the formation of the projecting patterns formed so as to overlap the first light-shielding layer and all or part of each of the second light-shielding layers also functions as the first light-shielding layer; and
each of the reflective areas being formed on the downside of the direction of rubbing with respect to the corresponding projecting pattern.

12. An electro-optical panel, comprising:
a first substrate;
a plurality of scanning lines and a plurality of data lines formed on the first substrate;
transmissive areas through which light is transmitted and reflective areas from which the light is reflected being formed on areas surrounded by the data lines and the scanning lines;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, the projecting patterns being formed so as to overlap the first light-shielding layer;
second light-shielding layers to prevent light leakage due to the formation of the projecting patterns formed so as to overlap the first light-shielding layer and all or part of each of the second light-shielding layers also functions as the first light-shielding layer; and
color filters including blue color filters being formed on the first substrate or beneath the second substrate, and each of the blue color filters being formed on the downside of the direction of rubbing with respect to the corresponding projecting pattern.

13. An electro-optical panel, comprising:
a first substrate;
a plurality of scanning lines and a plurality of data lines formed on the first substrate;
transmissive areas through which light is transmitted and reflective areas from which the light is reflected being formed on areas surrounded by the data lines and the scanning lines;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, the projecting patterns being formed so as to overlap the first light-shielding layer;
second light-shielding layers to prevent light leakage due to the formation of the projecting patterns are formed so as to overlap the first light-shielding layer and all or part of each of the second light-shielding layers also functions as the first light-shielding layer; and
color filters being formed on the first substrate or beneath the second substrate, and third light-shielding layers formed so that the color filters having the same color have apertures with the same area.

14. An electro-optical panel, comprising:
a first substrate;
a plurality of scanning lines and a plurality of data lines formed on the first substrate;
transmissive areas through which light is transmitted and reflective areas from which the light is reflected being formed on areas surrounded by the data lines and the scanning lines;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate;
electro-optic material filled between the first substrate and the second substrate, color filters of blue, green, and red being formed on the first substrate or beneath the second substrate,
the projecting patterns being formed so as to overlap the first light-shielding layer for every predetermined number of rows and being arranged such that the pair of colors of the color filters that are laterally adjacent to each projecting pattern is different for every row and all the pairs of colors appear for every predetermined number of rows; and
second light-shielding layers to prevent light leakage due to the formation of the projecting patterns formed so as to overlap the first light-shielding layer and all or part of each of the second light-shielding layers also functions as the first light-shielding layer.

15. An electro-optical panel, comprising:
a first substrate;
a plurality of scanning lines and a plurality of data lines are formed on the first substrate;
transmissive areas through which light is transmitted and reflective areas from which the light is reflected being formed on areas surrounded by the data lines and the scanning lines;
a second substrate;
a first light-shielding layer beneath the second substrate that covers the scanning lines and the data lines when the electro-optical panel is assembled;
projecting patterns, formed on the first substrate or beneath the second substrate, to control the distance between the first substrate and the second substrate; and
electro-optic material filled between the first substrate and the second substrate,
the projecting patterns being formed on flat areas over the first light-shielding layer, and second light-shielding layers to prevent light leakage due to the formation of the projecting patterns formed so as to overlap the first light-shielding layer and all or part of each of the second light-shielding layers also functions as the first light-shielding layer.

16. Electronic equipment having the electro-optical panel according to claim 1.
